(19) United States
(12) Patent Application Publication
(10) Pub. No.: US 2009/0010178 A1
(43) Pub. Date: Jan. 8, 2009

(54) CORDLESS MAINS POWERED FORM FACTOR FOR MESH NETWORK ROUTER NODE

(75) Inventor: Mark Tekippe, Story City, IA (US)

Correspondence Address: SCHWEGMAN, LUNDBERG & WOESSNER, P.A., P.O. BOX 2938, MINNEAPOLIS, MN, 55402, US

(73) Assignee: Digi International Inc., East Minnetonka, MN (US)

(21) Appl. No.: 11/773,266

(22) Filed: Jul. 3, 2007

(51) Int. Cl. H04L 12/28

(52) U.S. Cl. 370/254

(57) ABSTRACT

An apparatus comprising a cordless, mains powered mesh network router. The mains powered mesh network router includes a controller configured to initiate a first indication when the mains powered mesh network router is mounted to an electrical outlet, and initiate a second indication when the controller joins a mesh network. Other devices, methods and systems are disclosed.

### TECHNICAL FIELD

This document relates generally to devices and systems that communicate via a network and in particular to communication via a mesh network.

### BACKGROUND

Electronic devices are often interconnected by wireless means to form a network, such as a computer network for example. The wireless network includes nodes that communicate data using radio frequency (RF) signals. A mesh network is a network in which the network nodes are able to communicate with each other via multiple hops. The nodes of the network are able to reconfigure communication paths around blocked or malfunctioning nodes. A wireless mesh network may be implemented using a wireless local area network (WLAN).

A wireless mesh network may be a wireless ad hoc mesh network. A wireless ad hoc network is self configuring. The network router nodes are able to organize arbitrarily into a network. The network topology of a wireless ad hoc mesh network may change rapidly.

A wireless mesh network may be a wireless personal area network (WPAN). WPANs tend to be used for general purpose, inexpensive, mesh networks such as for industrial control or home automation for example. An example of a WPAN is a ZigBee wireless network. A ZigBee network implements the IEEE 802.15.4 communication protocol standard for WPANs. WPAN node devices are typically low power [e.g., 1 milliwatt (mW) to 250 mW] and have lower data rates [e.g., 250 kilobits per second (kbps)] than node devices for other networks.

WPAN nodes are devices that typically powered by either an external power brick requiring a power cord or are powered by batteries. WPAN node devices having an external power brick are bulky devices that can make a WPAN less convenient to implement. Such WPAN node devices often require additional mounting hardware or a special installation which can be expensive and cumbersome.

A WPAN implemented using battery powered node devices tries to conserve power and extend the life of the batteries of the individual nodes. To extend the battery life of battery-powered router nodes in WPAN applications, the nodes may be required to enter a very low power mode for most of the time that the network is operating, which results in decreased throughput. Periods of high network traffic can quickly drain batteries. Furthermore, when batteries reach the end of their life, battery powered nodes require more maintenance and pose a higher risk of network failure. The present inventor has recognized a need for improvement in implementing a wireless mesh network.

### OVERVIEW

This document describes devices, systems, and methods used to implement a mesh network. One apparatus embodiment includes a cordless, mains powered wireless mesh network router. The mains powered mesh network router includes a controller configured to initiate a first indication when the mains powered mesh network router is mounted to an electrical outlet, and to initiate a second indication when the mains powered mesh network router joins a mesh network.

One method embodiment includes deploying a plurality of cordless, mains powered mesh network routers to establish a wireless mesh network infrastructure, and commissioning the cordless, mains powered mesh network routers. Commissioning a cordless, mains powered mesh network router includes providing a first indication from the mains powered mesh network router when the mains powered mesh network router is mounted to an electrical outlet, and providing a second indication from the mains powered mesh network router when the mains powered mesh network router joins the mesh network.

One system embodiment includes a plurality of cordless, mains powered mesh network routers to implement a wireless mesh network. A cordless, mains powered mesh network router includes a controller configured to initiate a first indication when the mains powered mesh network router is mounted to an electrical outlet, and initiate a second indication when the mains powered mesh network router joins the mesh network.

This overview of the subject matter of the present patent application is not intended to provide an exclusive or exhaustive explanation of the invention. The detailed description is included to provide further information about the subject matter of the present patent application.

### BRIEF DESCRIPTION OF THE DRAWINGS

FIG. 1 is an illustration of a cordless, mains powered mesh network router.

FIG. 2 is a block diagram of portions of an embodiment of a device to implement a mesh network.

FIG. 3 is a block diagram of portions of another embodiment of a device to implement a mesh network.

FIGS. 4A and 4B illustrate embodiments of locking mechanisms to secure a mains powered mesh network router to an electrical outlet.

FIG. 5 is a block diagram of portions of an embodiment of a system to implement a mesh network.

FIG. 6 shows a flow diagram of an embodiment of a method of implementing a mesh network using a plurality of cordless, mains powered mesh router nodes.

FIGS. 7A-C show an embodiment of implementing a wireless mesh network.

FIGS. 8A-B show another embodiment of implementing a wireless mesh network.

### DETAILED DESCRIPTION

In the following detailed description, reference is made to the accompanying drawings which form a part hereof, and in which is shown by way of illustration specific embodiments in which the invention may be practiced. It is to be understood that other embodiments may be utilized and structural changes may be made without departing from the scope of the present invention.

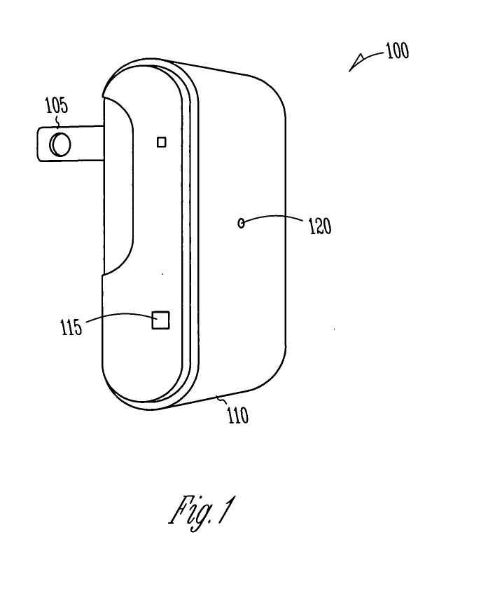

This document discusses, among other things, devices, systems, and methods for implementing a wireless mesh network. FIG. 1 is an illustration of a cordless, mains powered wireless mesh network router 100. In some embodiments, the mains powered mesh network router 100 is used to implement an ad hoc mesh network. In some embodiments, the mains powered mesh network router 100 is used to implement a node on a mesh network. The mesh network can be a WPAN. Examples of a WPAN include, without limitation, a ZigBee protocol network or any network using the IEEE 802.15.4 communication protocol standard for WPANs. Implementation of other mesh network protocols is within the scope of this document.

The mains powered mesh network router 100 is attachable to a power plug 105 to mount the mains powered mesh network router 100 to a standard wall outlet. The mains powered mesh network router 100 may include an antenna connector 115 and may include one or more LEDs 120.

The mains powered mesh network router 100 does not have an external power brick. Consequently, the mains powered mesh network router 100 has a very compact form factor. Having a single enclosure may improve reliability of the mains powered mesh network router 100 because the router does not have an external power brick which can be accidentally removed from the device and does not have dangling power cords.

Because the mains powered mesh network router 100 uses mains power and not a battery, degrading the network to conserve battery power is not necessary. In some embodiments, the power plug 105 is an interchangeable power plug to mount the mains powered router to the electrical outlet. This allows the power plug 105 to be interchanged with power plugs of different standards, such as a U.S. standard plug, U.K. standard, E.U. standard, Japan standard, and Australia standard for example. The mains powered mesh network router 100 also includes a universal power supply circuit able to operate at a variety of electrical outlet voltages. This allows only a single type of mains powered mesh network router 100 to be distributed internationally for deployment of mesh networks in a variety of countries.

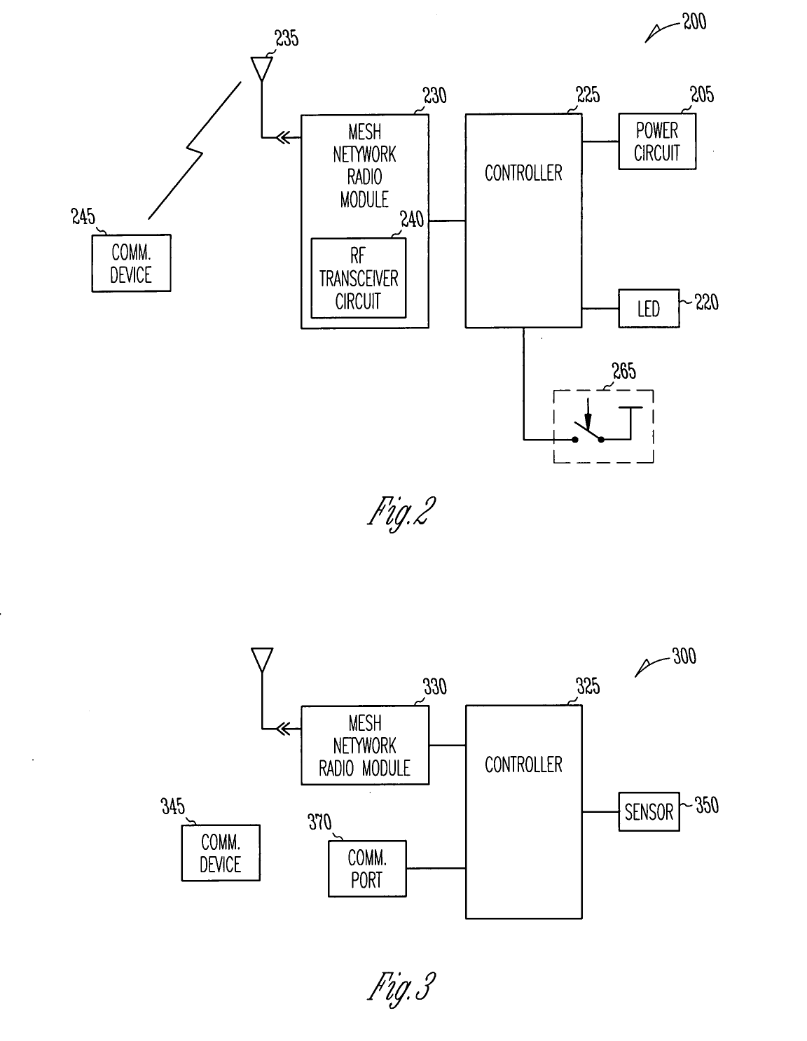

FIG. 2 is a block diagram of portions of an embodiment of a device 200 to implement a mesh network. The device 200 is the mains powered mesh network router 100 of FIG. 1 and may be used as a router node in a wireless mesh network. The device 200 includes a controller 225 and a mesh network radio module 230. The mesh network radio module 230 includes a radio frequency (RF) transceiver circuit 240 connectable to an antenna 235. In some embodiments, the antenna 235 may be internal to a housing of the device 200. An internal antenna may simplify deployment of the device and improve reliability. In some embodiments, the antenna 235 is included in the mesh network radio module 230. In some embodiments, the antenna 235 may be external to the housing of the device 200. Using an external antenna may allow the range of the device 200 to be extended.

The controller 225 can be implemented using hardware circuits, firmware, software or any combination of hardware, firmware and software. Examples, include a microcontroller, a logical state machine, and a processor such as a microprocessor, application specific integrated circuit (ASIC), or other type of processor. The controller 225 is configured to perform or execute a function or functions. Such functions correspond to modules, which are software, hardware, firmware or any combination thereof. Multiple functions may be performed in one or more modules.

The controller 225 and the mesh network radio module 230 perform the addressing and routing functions of a wireless router. For example, the controller 225 and the mesh network radio module 230 route packets of information using IEEE 802.15.4 communication protocol. It should be appreciated that the individual blocks within the block diagram do not necessarily correspond to discrete hardware structures. For example, some functionality of the controller 225 may be included in the mesh network radio module 230.

To facilitate deploying and commissioning the network infrastructure, the mains powered mesh network router provides several levels of indication as to the status of the deployment of a router node. In some embodiments, the controller 225 is configured to initiate a first indication when the mains powered mesh network router is mounted to an electrical outlet to provide power to the power circuit 205. The controller 225 initiates a second indication when the controller 225 joins, or is otherwise associated with, a mesh network. Joining the network may include the mains powered mesh network router being assigned an address by a mesh network coordinator. Joining the network may include active participation by the mains powered mesh network router in the mesh network. Joining the network may include the mains powered mesh network router detecting the network and transmitting and receiving data over the mesh network.

The status indications may be physical indications or logical indications. A physical indication provides an indication of router status to someone near the device 200. In some embodiments, the device 200 includes at least one light emitting diode (LED) 220 and the controller 225 provides first and second physical indications using the LED 220. For the first indication, the controller 225 sets the LED 220 to an on state to provide constant illumination when the mains powered mesh network router is mounted to the electrical outlet to provide power, but the mesh network is not yet detected by the controller 225. The on state includes the case where the LED 220 is pulsed at a rate that is undetectable visually and the LED appears on.

For the second physical indication, controller 225 alternates the LED 220 or a second LED between an on state and an off state when the mains powered mesh network router joins the mesh network. In some embodiments, the second indication provided by the controller 225 includes alternating the LED 220 between the on and off states according to a connection status of the router. In certain embodiments, the controller 225 flashes the LED 220 between the on and the off states to indicate error codes (e.g., the LED 220 flashes 3 times to indicate the error code No. 3, followed by a pause in the flashing). In certain embodiments, the controller 225 flashes the LED 220 at different constant rates to indicate the quality or “strength” of the signal (e.g., the stronger the signal detected by the mesh network radio module 230, then the faster the constant rate of flashing).

In some embodiments, the controller 225 displays different colors using the LED 220 to indicate status. In certain embodiments, the controller 225 displays different colors using the LED 220 to indicate different error codes. In certain embodiments, the controller 225 displays different colors using the LED 220 to indicate whether the mains powered mesh network router has joined the network (e.g., red to indicate the router has not joined the network and green to indicate the router has joined the network).

A logical indication may provide an indication of router status to someone located at the device or to someone located remote from the device 200. An example of a logical indication includes the mains powered mesh network router communicating status with a separate communication device. In some embodiments, the controller 225 communicates information with a separate wireless, portable communication device 245 using the mesh network radio module 230. Examples of the communication device 245 include a hand-held wireless communication device such as a personal data assistant (PDA) and a palm pilot used locally at the device 200. In some embodiments, the mains powered mesh network router communicates status with a remote communication device via the mesh network. Examples of a remote communication device include a device communicating with a remote network node using a serial port, a server communicating with the network, or a remote gateway network. The mains powered mesh network router is able to communicate status at any time with the communication device 245.

For the first indication, the controller 225 communicates information with the communication device 245 when power is applied to the mains powered mesh network router by the mounting to the electrical outlet. The mains powered mesh network router then may or may not try to automatically join the mesh network depending on its configuration settings.

For the second indication, the controller 225 is configured to communicate information with the communication device 245 when the mains powered mesh network router joins the mesh network. However, if the configuration settings of the router are not appropriate, the router will need to be commissioned, or configured, by the communication device 245 in order to join the network. The communication device 245 commissions the mains powered mesh network router by communicating configuration commands to the controller 225. When the mains powered mesh network router joins the network the status provided by the second indication can be viewed locally by a local communication device 245 or remotely via the mesh network.

In some examples, the mains powered mesh network router includes a switch 265, such as a push button, communicatively coupled to the controller 225. The controller 225 is configured to initiate joining the mesh network when the switch 265 is activated. Someone deploying the mesh network mounts the mains powered mesh network router on an electrical output to apply power to the device 200. The device 200 provides the first physical or logical indication. The switch 265 is activated after the first indication and the device 200 then attempts to join the mesh network. The device 200 then provides the second physical or logical indication to indicate the status of the network. In certain embodiments, activating the switch 265 places the device in reconfiguration mode and the communication device can be used to reconfigure the router at any time. In certain embodiments, activating the switch 365 may also be used to reset the mains powered mesh network router, such as by holding down the switch 265 to activate the switch 265 for a period of time.

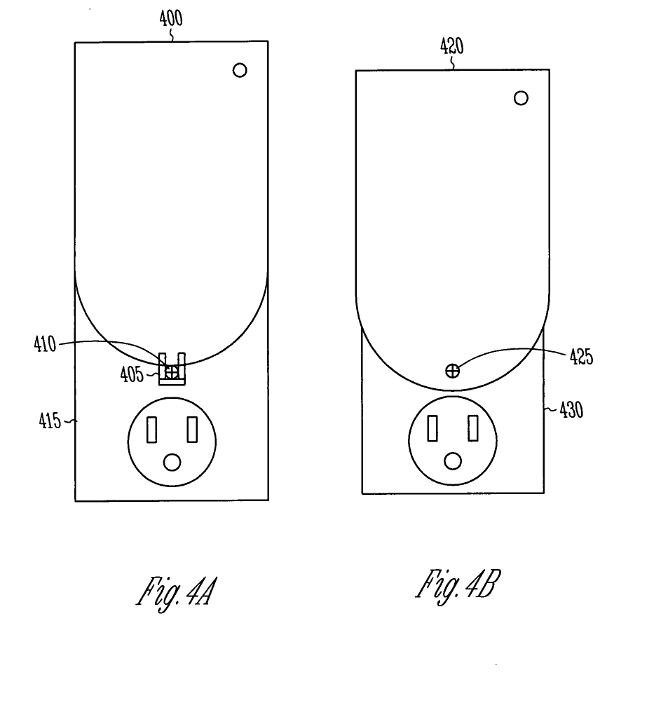

FIG. 3 is a block diagram of portions of another embodiment of a device 300 to implement a mesh network. The device 300 includes a controller 325 and mesh network radio module 330. The device 300 also includes a communication port 370. The controller 325 communicates information with a separate communication device 345 using at least one of the mesh network radio module 330 or the communication port 370, such as to provide the first or second indication for example. In some embodiments, the communication port 370 is an infrared (IR) port and the device 300 communicates information wirelessly with the communication device 345 using IR signals. In some embodiments, the communication port 370 is a serial port, such as a universal serial bus (USB) port for example, and device 300 communicates information with the communication device 345 using the serial port. The serial port may connect to the communication device via a wire or capable or the serial port may be a wireless port. Further examples of the communication device 345 include a laptop computer, a desktop computer, a server, or a gateway network.

In certain embodiments, the communication device 345 communicates network configuration information to the device 300 via the mesh network. The communication device 345 may be connected to another mains powered mesh network router node in the network via a serial port. Network information is communicated between a newly deployed mains powered mesh network router and the communication device 345 via the existing mesh network.

In some embodiments, the device 300 includes a sensor 350. The sensor 350 provides an electrical sensor signal according to a measured property. For example, the sensor 350 includes an optical sensor and provides an electrical signal when light exceeds a threshold amount of light or provides an electrical signal proportional to light intensity. In another example, the sensor 350 includes a heat sensor and provides an electrical signal when heat sensed exceeds a threshold amount, or provides an electrical signal proportional to heat intensity. Other examples of the sensor 350 include a smoke sensor and a motion sensor. The controller 325 is configured to communicate information about the electrical sensor signal via the mesh network.

As discussed previously in regard to FIG. 1, the mains powered mesh network router 100 is attachable to a power plug 105. In some embodiments, the mains powered mesh network router 100 includes a locking mechanism to secure the mains powered mesh network router to the electrical outlet. This helps prevent theft if the mains powered mesh network router 100 is installed in a higher traffic area, such as a hospital or an industrial location for example. A locking mechanism also improves reliability by preventing unplugging of the mains powered mesh network router 100 either accidentally or mistakenly.

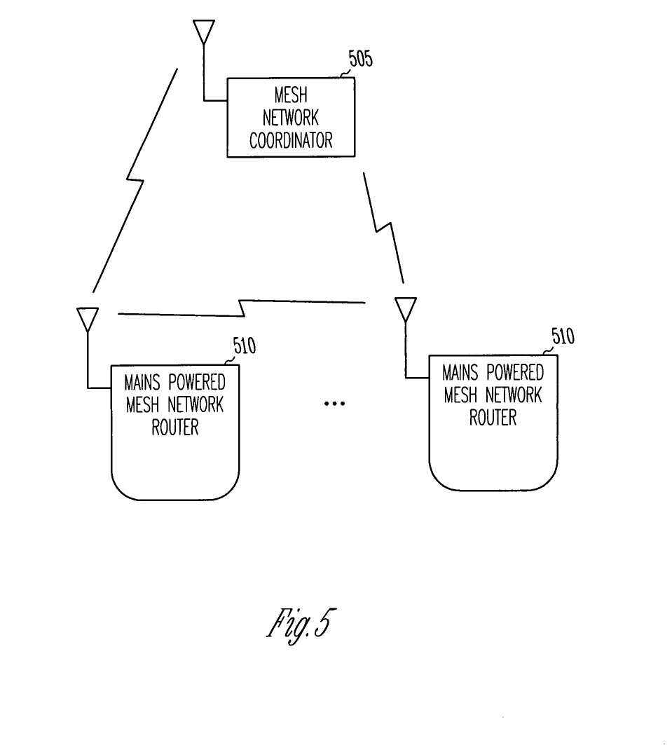

FIGS. 4A and 4B illustrate embodiments of such locking mechanisms. In FIG. 4A, the housing of a mains powered mesh network router 400 includes a tab 405 that accepts a screw 410 to secure the mains powered mesh network router 400 to the faceplate 415 of the electrical outlet. The tab 405 may be located in other positions on the housing to secure the mains powered mesh network router 400 to the faceplate 415 (e.g., the mains powered mesh network router 400 may be plugged into the lower outlet and tab may be located on the top of the housing). In FIG. 4B, the housing of a mains powered mesh network router 400 includes an opening to accept the screw 425 through the housing itself to secure the mains powered mesh network router 420 to the faceplate 430 of the electrical outlet. In certain embodiments, the locking mechanism may include a bracket included on the faceplate of the electrical outlet to secure the means powered router to the faceplate.

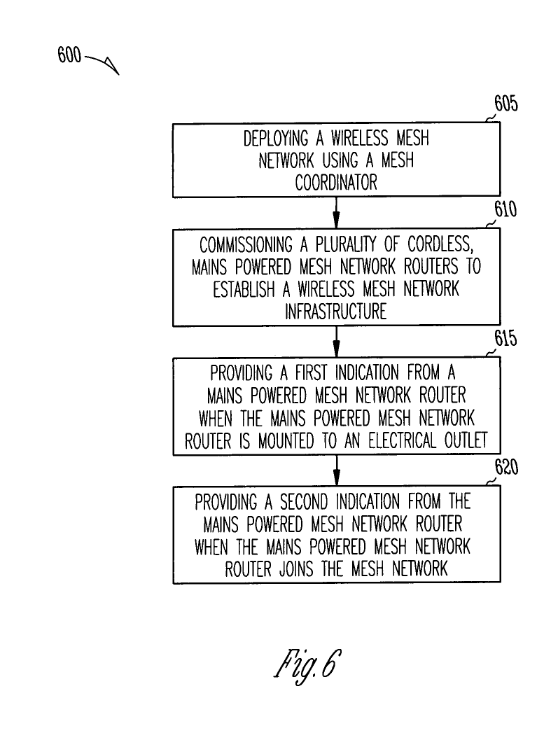

FIG. 5 is a block diagram of portions of an embodiment of a system 500 to implement a mesh network. The system 500 includes a plurality of cordless, mains powered mesh network routers 510 to be deployed to establish a mesh network infrastructure. In some embodiments, the network is a wireless ad hoc mesh network. The mains powered mesh network routers 510 include hardware and/or software that enables them to self organize into the mesh network. The mains powered mesh network routers 510 include a mesh network radio module that enables them to detect an existing network and/or establish links with detected neighbor router nodes.

In some embodiments, the mesh network is a WPAN and includes a mesh network coordinator 505. In some embodiments, the mesh network coordinator 505 is also a cordless, mains powered mesh network router. The cordless, mains powered mesh network coordinator 505 may form the root of the mesh network and may be a bridge to other networks. The cordless, mains powered mesh network coordinator 505 can store network configuration information.

In some embodiments, the mains powered mesh network coordinator 505 initiates the wireless network. The mains powered mesh network routers 510 are deployed by being mounted to electrical outlets in the network area by the power plug 105 shown in FIG. 1, thereby providing power to the mains powered mesh network routers 510. The mains powered mesh network routers 510 each include a controller that initiates a first indication when the mains powered mesh network router is mounted to the electrical outlet, and initiates a second indication when the controller detects the mesh network and associates to the mesh network. The indications may be physical or logical. Packet routing in the network can be independent of any parent/child relationships among the router nodes that are established when the router nodes join or associate with, the mesh network.

According to some embodiments, the mains powered mesh network routers 510 provide physical indications of the status of the router using an LED. A first indication includes setting the LED to an on state when the mains powered mesh network router 510 is powered on. A second indication includes alternating the LED between on and off states when the controller joins the mesh network. In some embodiments, a mains powered mesh network router 510 includes a switch, such as a push button. In certain embodiments, the mains powered mesh network router 510 does not attempt to join the network until the switch is depressed, or pushed, after power up.

According to some embodiments, the mesh network coordinator 505 and the mains powered mesh network routers 510 communicate with a wireless portable communication device to provide logical indications of the status of the network and to communicate network configuration information. The mains powered mesh network routers 510 provide the first and second indications by communicating information with a separate communication device. In some embodiments, the mains powered mesh network routers 510 communicate wirelessly with the communication device using a mesh network radio module. In some embodiments, the mains powered mesh network routers 510 communicate wirelessly with the communication device using an IR port. In some embodiments, the mains powered mesh network routers 510 communicate with the communication device using a serial port that may be either a wired or a wireless port.

The first indication includes communicating information with the portable communication device when the mains powered mesh network router 510 is powered on. The second indication includes communicating information with the portable communication device when the mains powered mesh network router 510 joins the mesh network. In certain embodiments, the mains powered mesh network router 510 does not attempt to associate to the mesh network until an enable message (e.g., an acknowledge message) is received from the communication device after the first indication.

In certain embodiments, the mains powered mesh network router 510 receives network configuration information from the communication device. The network configuration information may include network commands. In certain embodiments, the mains powered mesh network router 510 receives network configuration information from the mesh network coordinator 505 via the mesh network. In certain embodiments, a communication device communicates with the mesh network coordinator 505 via a serial port. The mains powered mesh network router 510 receives network configuration information from the communication device via the mesh network coordinator 505 and the mesh network.

According to some embodiments, the mesh network may be large and may include hundreds to thousands of router nodes. It would be convenient in such a large network to provide configuration information over the network. The communication device may be a server which includes the deployment plan for the network. The server communicates configuration information with the mesh network coordinator 505. Those deploying the mesh network physically distribute the mains powered mesh network routers 510.

If the mesh network is a WPAN, the deployment may start with a mesh network coordinator 505. The status indication may be first checked locally to see if a deployed router has joined the network. The mesh network coordinator is able to see all nodes connected to it and all children nodes. Because the server communicates with the mesh network coordinator node 505, the server is able to check the status of the entire mesh network and make sure the deployment plan has been correctly implemented.

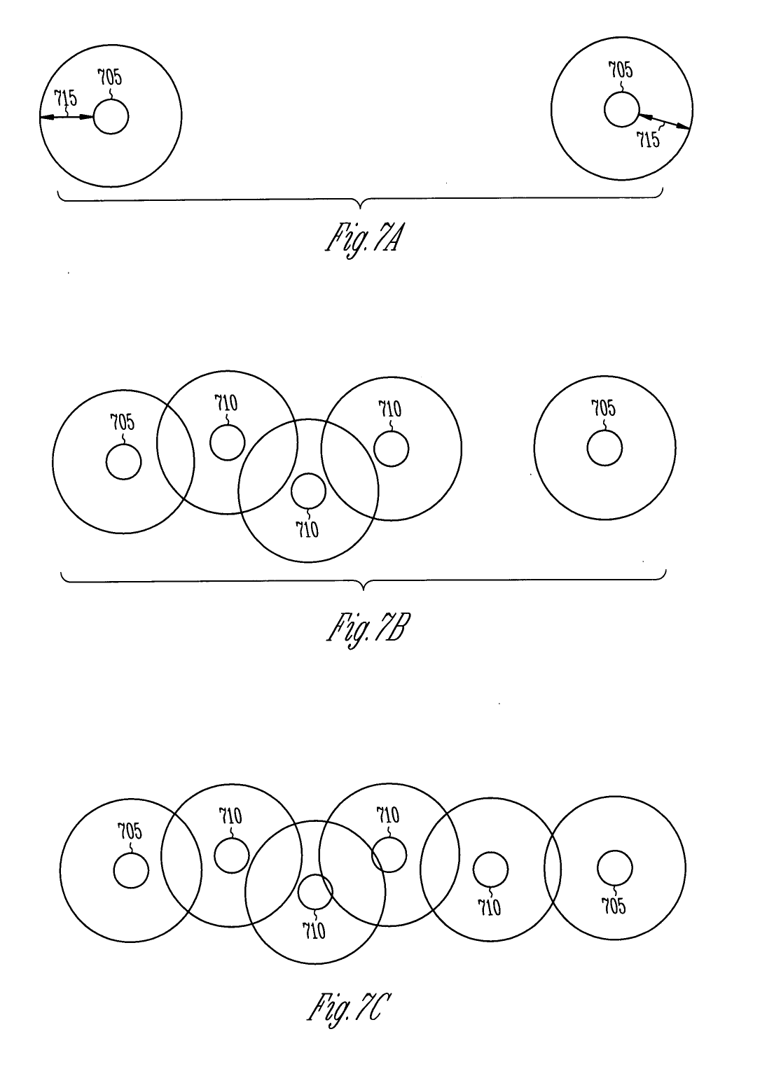

FIG. 6 shows a flow diagram of an embodiment of a method 600 of implementing a mesh network using a plurality of cordless, mains powered mesh router nodes. In some embodiments, the mesh network includes a WPAN. At block 605, a wireless mesh network is deployed using a mesh network coordinator. At block 610, a plurality of cordless, mains powered mesh network routers are commissioned as network router nodes to establish the infrastructure for the mesh network. The mains powered mesh network routers are commissioned by configuring the routers. The routers are configured by providing configuration information, such as configuration commands, to the routers. The routers can be configured locally or remotely. In some embodiments, the routers are configured locally by communicating configuration information with a local communication device, such as a portable handheld wireless communication device or a communication device that connects to a router using a serial port for example. In some embodiments, the routers are configured remotely by communicating configuration information over the network.

In some embodiments, the mesh network coordinator is also a cordless, mains powered mesh network router. Other devices, such as a mains powered mesh network router or a network end device, become part of the network by associating with the mesh network coordinator or another mains powered mesh network router that is already part of the mesh network.

At block 615, commissioning a cordless mains powered mesh network router includes providing status indications from the router. The indications from the mains powered mesh network router include a first indication when the mains powered mesh network router is mounted to an electrical outlet. In some examples, mounting a mains powered mesh network router includes mounting the router to the electrical outlet using an interchangeable power plug. In some examples, mounting a mains powered mesh network router includes securing the mains powered mesh network router to the electrical outlet using a locking mechanism. At block 620, commissioning a mains powered mesh network router also includes providing a second indication from the mains powered mesh network router when the mains powered mesh network router joins the mesh network.

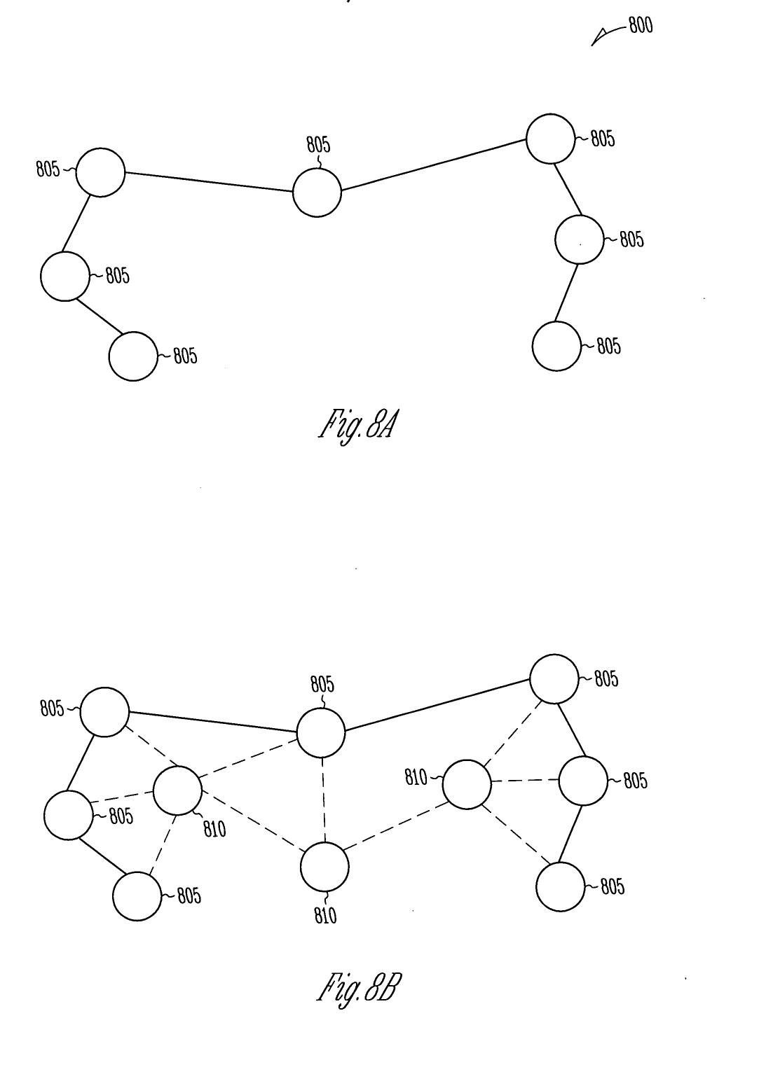

FIGS. 7A-C show an embodiment of implementing a wireless mesh network. FIG. 7A shows two mesh network devices 705 indicated by the smaller circles. The larger circle represents the range 715 of each device. The range of the devices does not overlap and the devices are not able to communicate with each other. Mains powered mesh network routers 710 may be used to conveniently and inexpensively “patch” together a mesh network between the two mesh network devices 705. In FIG. 7B, mains powered mesh network routers 710 are iteratively placed from the mesh network device 705 on the left toward the mesh network device 705 on the right, or vice versa. The deployed mains powered mesh network routers 710 may or may not include a mains powered mesh network coordinator, depending on the topology of the mesh network chosen.

Starting from either mesh network device 705, a mains powered mesh network router 710 is placed near the limit of the range of the mesh network 705. Subsequent mains powered mesh network routers 710 are placed near the range limit of the adjacent router. Someone deploying the network could tell from physical or logical indications provided by the mains powered mesh network routers 710 that the router was placed within range of the mesh network and that the router has joined the mesh network and effectively expanded the mesh network. Individual nodes could be commissioned, if necessary, using a portable communication device. In FIG. 7C, the mesh network is complete and the two mesh network devices 705 are connected by the wireless mesh network.

FIGS. 8A-B show another embodiment of implementing a wireless mesh network. FIG. 8A shows network nodes 805 of an existing wireless mesh network 800. The solid lines indicate existing communication paths and are not intended to indicate hard-wired node connections. It is desired to improve the wireless mesh network 800 by deploying and commissioning additional network nodes. FIG. 8B shows that additional wireless mains powered mesh network routers 810 are deployed within range of the mesh network to add additional mesh network paths. This increases the number of network paths available (indicated by dashed lines) and increasing the bandwidth of the mesh network 800. The additional wireless mains powered mesh network routers 810 may be commissioned using a portable communication device or via the existing mesh network 800.

Returning to FIG. 1, the mains powered mesh network router 100 provides a simple to implement solution for users wanting to install or expand a mesh network infrastructure. Because the mains powered mesh network router 100 includes a wireless transceiver, a power supply, interchangeable power plugs, and is easily configured, the mains powered mesh network router 100 is a complete solution for wireless mesh network nodes that can be used to quickly set up a mesh network.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations, or variations, or combinations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own.

What is claimed is:

1. An apparatus comprising a cordless, mains powered mesh network router, wherein the mains powered mesh network router includes a controller configured to:
initiate a first indication when the mains powered mesh network router is mounted to an electrical outlet; and
initiate a second indication when the mains powered mesh network router joins a wireless mesh protocol network.

2. The apparatus of claim 1, wherein the mesh network is a ZigBee protocol network, and the controller is configured to initiate the second indication when the mains powered mesh network router joins the ZigBee protocol network.

3. The apparatus of claim 1, wherein the mesh network implements an IEEE 802.15.4 communication protocol standard for wireless personal area networks (WPANs), and wherein the controller is configured to initiate the second indication when the mains powered mesh network router joins the IEEE 802.15.4 communication protocol network.

4. The apparatus of claim 1, wherein the mains powered mesh network router includes an interchangeable power plug to mount the mains powered mesh network router to the electrical outlet.

5. The apparatus of claim 1, wherein the mains powered mesh network router includes a locking mechanism to secure the mains powered mesh network router to the electrical outlet.

6. The apparatus of claim 1, wherein the mains powered mesh network router includes a light emitting diode (LED) communicatively coupled to the controller, and wherein the first indication includes setting the LED to the on state.

7. The apparatus of claim 1, wherein the mains powered mesh network router includes a light emitting diode (LED) communicatively coupled to the controller, and wherein the second indication includes alternating the LED between on and off states when the mains powered mesh network router joins a wireless mesh protocol network.

8. The apparatus of claim 7, including a mesh network radio module communicatively coupled to the controller, wherein the controller is configured to alternate the LED between the on and off states at a rate according to a network connection status of the mains powered mesh network router.

9. The apparatus of claim 1, wherein the mains powered mesh network router includes a mesh network radio module communicatively coupled to the controller, and wherein the second indication includes the controller communicating network status information with a separate communication device.

10. The apparatus of claim 9, wherein the first indication includes communicating power-up status information with the separate communication device.

11. The apparatus of claim 9, wherein the separate communication device is configured to communicate network configuration information to the mains powered mesh network router.

12. The apparatus of claim 1, wherein the mains powered mesh network router includes a communication port communicatively coupled to the controller, and wherein the second indication includes the controller communicating network status information with a separate communication device via the communication port.

13. The apparatus of claim 1, wherein the mains powered mesh network router includes a switch communicatively coupled to the controller, and where in the controller is configured to initiate joining the mesh network when the switch is activated.

14. The apparatus of claim 1, wherein the mains powered mesh network router includes a sensor, communicatively coupled to the controller, configured to provide an electrical sensor signal according to a measured property, and wherein the controller is configured to communicate information about the electrical sensor signal via the mesh network.

15. A method comprising:
deploying a plurality of cordless, mains powered mesh network routers to establish a wireless mesh network infrastructure; and
commissioning the cordless, mains powered mesh network routers, wherein commissioning a cordless, mains powered mesh network router includes:
providing a first indication from the mains powered mesh network router when the mains powered mesh network router is mounted to an electrical outlet; and
providing a second indication from the mains powered mesh network router when the mains powered mesh network router joins the mesh network.

16. The method of claim 15, wherein providing the first indication includes setting an LED of the mains powered mesh network router to an on state.

17. The method of claim 15, wherein providing the second indication includes alternating a light emitting diode (LED) of the mains powered mesh network router between on and off states when the mains powered mesh network router detects the mesh network.

18. The method of claim 17, wherein providing the second indication includes alternating the LED between the on and off states at a rate according to a network connection status of the mains powered mesh network router.

19. The method of claim 15, wherein providing the second indication includes communicating network status information between the mains powered mesh network router and a separate communication device when the mains powered mesh network router joins the mesh network.

20. The method of claim 19, also including communicating network configuration information to the mains powered mesh network router from the communication device.

21. The method of claim 15, wherein providing the first indication includes communicating information from the mains powered mesh network router to a separate communication device when powered is applied to the mains powered mesh network router.

22. The method of claim 15, wherein deploying the mesh network includes deploying a wireless personal area network (WPAN) using one of the cordless, mains powered mesh network router as a mesh network coordinator.

23. The method of claim 15, including communicating sensor information from the mains powered mesh network router via the mesh network.

24. The method of claim 15, wherein commissioning a cordless, mains powered mesh network router includes enabling the mains powered network router to join the mesh network upon activation of a switch included in the mains powered mesh network router.

25. The method of claim 15, wherein deploying a wireless mesh network includes deploying a ZigBee protocol network.

26. The method of claim 15, wherein deploying a wireless mesh network includes deploying a mesh network that implements an IEEE 802.15.4 communication protocol standard for wireless personal area networks (WPANs).

27. A system comprising a plurality of routers to implement a wireless mesh network, including:
a mesh network coordinator; and
a plurality of cordless, mains powered mesh network routers to be commissioned to establish a mesh network infrastructure, wherein a cordless, mains powered mesh network router includes a controller configured to:
initiate a first indication when the mains powered mesh network router is mounted to an electrical outlet; and
initiate a second indication when the mains powered mesh network router joins the mesh network.

28. The system of claim 27, wherein the mains powered mesh network router includes a light emitting diode (LED) communicatively coupled to the controller, and wherein the controller is configured to set the LED to the on state when the mains powered mesh network router is mounted to the electrical outlet.

29. The system of claim 27, wherein the mains powered mesh network router includes an LED communicatively coupled to the controller, and wherein the controller is configured to alternate the LED between on and off states when the mains powered mesh network router joins the mesh network.

30. The system of claim 27, wherein the mains powered mesh network router includes a mesh network radio module communicatively coupled to the controller, and wherein the controller is configured to communicate information with a separate communication device when the mains powered mesh network router joins the mesh network.

31. The system of claim 30, wherein the controller is configured to communicate information with the portable communication device when power is applied to the mains powered mesh network router.

32. The system of claim 27, wherein the mains powered mesh network router includes a communication port communicatively coupled to the controller, and wherein the controller is configured to communicate information with a separate communication device via the communication port when the mains powered mesh network router joins the mesh network.

33. The system of claim 27, wherein the mains powered mesh network router is attachable to an interchangeable power plug to mount the mains powered mesh network router to the electrical outlet.

34. The system of claim 27, wherein the mains powered mesh network router includes a sensor configured to provide an electrical sensor signal according to a measured property, and wherein the mains powered mesh network router is configured to communicate information about the electrical sensor signal via the mesh network.

35. The system of claim 27, wherein the mesh network coordinator is a cordless, mains powered mesh network router.

36. The system of claim 27, wherein the mesh network is a ZigBee protocol network and the mesh network coordinator is a ZigBee coordinator.

37. The system of claim 27, wherein the mesh network implements an IEEE 802.15.4 communication protocol standard for wireless personal area networks (WPANs).
